(19) United States
(12) Patent Application Publication
(10) Pub. No.: US 2011/0109615 A1
(43) Pub. Date: May 12, 2011

(54) ENERGY SAVING DRIVING SEQUENCE FOR A DISPLAY

(75) Inventors: Marc Maurice Mignard, San Jose, CA (US); Jae Hyeong Seo, Pleasanton, CA (US); Pavankumar Mulabagal, San Jose, CA (US)

(73) Assignee: QUALCOMM MEMS Technologies, Inc., San Diego, CA (US)

(21) Appl. No.: 12/617,582

(22) Filed: Nov. 12, 2009

(51) Int. Cl. G09G 5/00

(52) U.S. Cl. 345/214

(57) ABSTRACT

A method of writing a display image to a display having an array of pixels according to a selected driving sequence. One driving sequence includes addressing each color row in a line of the array in a sequence before addressing a second line. Another driving sequence includes addressing a first color row of each line in the array before addressing a second color row of each line in the array.

### BACKGROUND

1. Field of the Invention

The present invention relates to addressing schemes for reducing power consumption necessary to address a display.

2. Description of Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable minor position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a block diagram of an array of interferometric modulators organized by lines and color rows.

FIG. 9 is a block diagram of an array of interferometric modulators being addressed in per line row sequence.

FIG. 10 is a block diagram of an array of interferometric modulators being addressed in entire array color row sequence.

FIG. 11 is a block diagram of an array of interferometric modulators being addressed in a combination of per line row sequence and entire array color row sequence.

FIG. 12 is a plot of the relative power consumption of driving an array of interferometric modulators according to different addressing sequences.

FIG. 13 is a flowchart of an embodiment of the process of displaying an image on an array of interferometric modulators of the embodiment of FIG. 8.

FIG. 14 is a flowchart of an embodiment of a process of addressing an array of interferometric modulators of the embodiment of FIG. 8.

FIG. 15 is a flowchart of an embodiment of the row addressing order determining step of the process in FIG. 14.

### DETAILED DESCRIPTION

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Conventional approaches to reducing power consumption in MEMS display devices have included various techniques that each tends to compromise the user experience by decreasing the quality of the image displayed to the user. These approaches have included decreasing the resolution or complexity of displayed images, decreasing the number of images in the sequence over a given time period, and decreasing the grayscale or color intensity depth of the image. Other suggestions have been made to reduce power consumption by different methods of addressing the display, however, they have been too complex, such that they require more power to solve the computation than power saved from the addressing of the display. Methods and devices are described herein which are configured to reduce power consumption by determining a row-addressing order based on attributes of the image data, and reducing the number of column charging transitions necessary to write an image to the display. One embodiment provides a method of efficiently computing a row-addressing order for a display device and addressing the display.

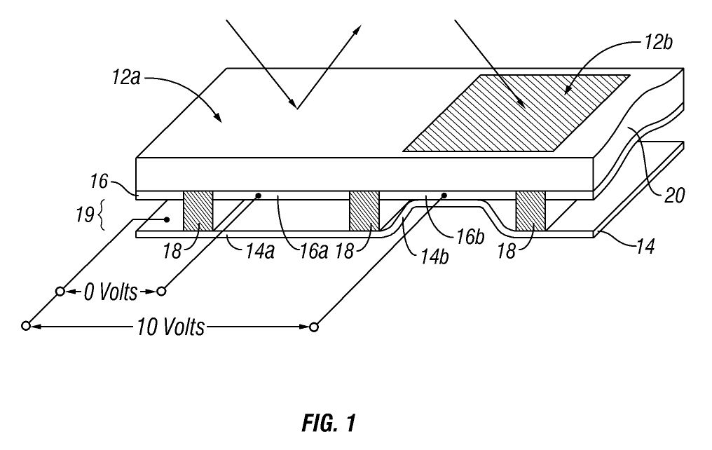

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form column electrodes in a display device as described further below. The movable reflective layers 14a, 14b may be formed as a series of parallel strips of a deposited metal layer or layers (orthogonal to the column electrodes of 16a, 16b) to form rows deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form row electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

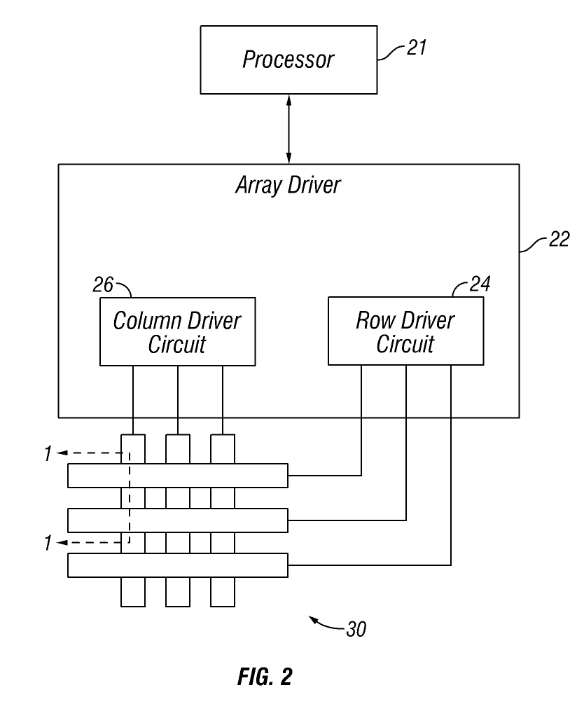

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

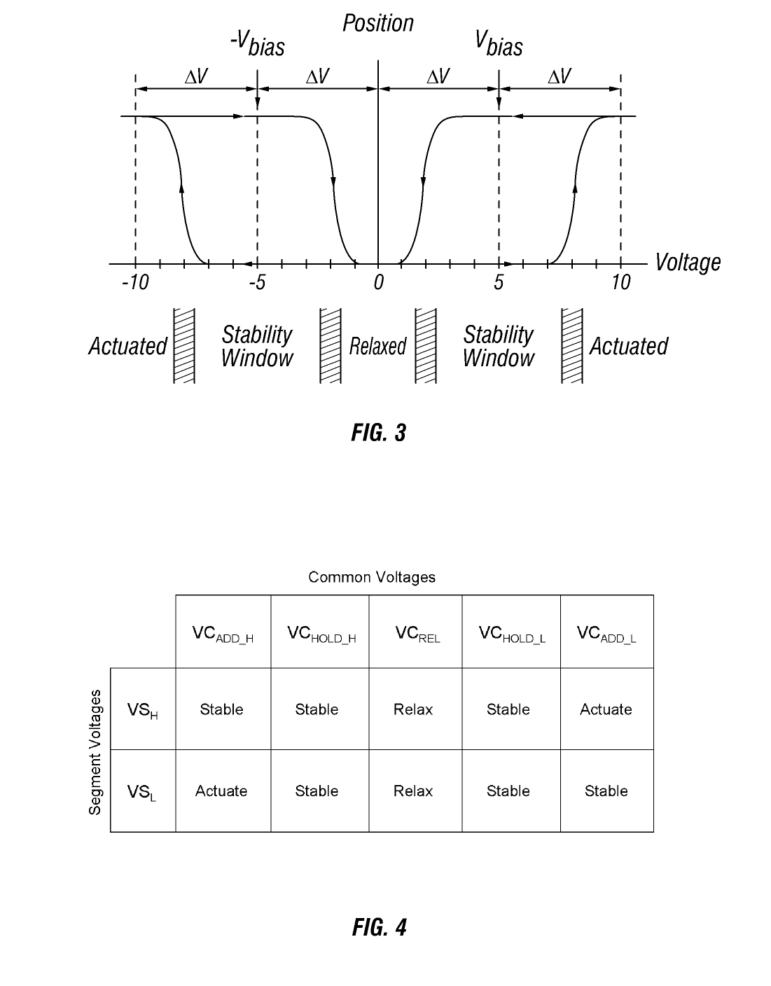

FIG. 3 is a diagram of movable minor position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

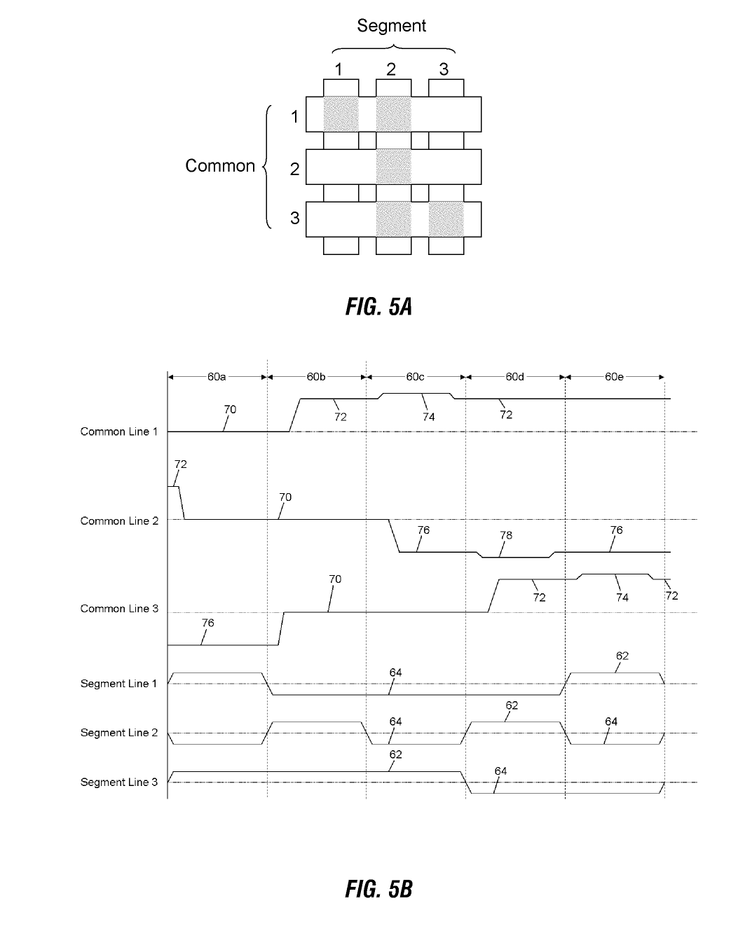

FIGS. 4 and 5 illustrate one possible actuation protocol for driving an array of electromechanical devices such as an array of interferometric modulators. FIG. 4 illustrates a possible set of column and row voltage levels that may be used for modulators exhibiting the hysteresis properties illustrated in FIG. 3. In the embodiment of FIG. 4 (also see FIG. 5A), as many as five or more possible voltages may be applied along a common line (which may be either a row or column line, in various embodiments) in order to address specific common lines, and at least two possible voltages may be applied along segment lines to write data to the common line(s) currently being addressed.

When a release voltage VC_{REL} is applied along a common line, all interferometric modulator elements along the common line will be placed in a relaxed state, alternatively referred to as a released or unactuated state, regardless of the voltage applied along the segment lines. The release voltage VC_{REL} and the high and low segment voltages VS_{H} and VS_{L} are selected accordingly. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line. The difference between the high and low segment voltage, also referred to as the segment voltage swing, is less than the width of the relaxation window.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. A relaxed modulator will remain in a relaxed position, and an actuated modulator will remain in an actuated position. The hold voltages are selected such that the pixel voltage will remain within a stability window of the interferometric modulator both when the high segment voltage VS_{H} and the low segment voltage VS_{L} are applied along the corresponding segment line. The segment voltage swing is thus less than the width of either the positive or the negative stability window.

When an addressing voltage is applied on a common line, such as high addressing voltage VC_{ADD}_{_{—}}_{H} or low addressing voltage VC_{ADD}_{_{—}}_{L}, data can be selectively written to the modulators along that line by application of segment voltages along the respective segment lines. The addressing voltages are selected such that when an addressing voltage is applied along a common line, the pixel voltage will be within a stability window when one of the segment voltages is applied along the segment line, but beyond the stability window when the other is applied, causing actuation of the pixel. The particular segment voltage which causes actuation will vary depending upon which addressing voltage is used. When the high addressing voltage VC_{ADD}_{_{—}}_{L} is applied along the common line, application of the high segment voltage VS_{H} will cause a modulator to remain in its current position, while application of the low segment voltage VS_{L} causes actuation of the modulator. The effect of the segment voltages will be the opposite when a low addressing voltage VCADD_L is applied, with high segment voltage VS_{H} causing actuation of the modulator, and low segment voltage VS_{L} having no effect on the state of the modulator.

In certain embodiments, only a high or a low hold voltage and address voltage may be used. Using both positive and negative hold and address voltages, however, allows the polarity of write procedures to be alternated, inhibiting charge accumulation which could occur after write operations of only a single polarity.

FIG. 5B is a timing diagram showing a series of common and segment voltage signals applied to the 3×3 array of FIG. 2 which will result in the display arrangement illustrated in FIG. 5A, where actuated modulators are non-reflective and illustrated as dark. Prior to writing the frame illustrated in FIG. 5A, the pixels can be in any state, but the write procedure illustrated in the timing diagram of FIG. 5B releases each modulator in a given common line prior to addressing the common line.

During the first line time 60a, none of common lines 1, 2, or 3 are being addressed. A release voltage 70 is applied on common line 1. The voltage applied on common line 2 begins at a high hold voltage 72 and moves to a release voltage 70. A low hold voltage 76 is applied along common line 3. Thus, the modulators (1,1), (1,2), and (1,3) along common line 1 remain in a relaxed state for the duration of the first line time 60a, the modulators (2,1), (2,2), and (2,3) along common line 2 will move to a relaxed state, and the modulators (3,1), (3,2), and (3,3) along common line 3 will remain in their previous state. The segment voltages applied along segment lines 1, 2, and 3 will have no effect on the state of the interferometric modulators, as none of common lines 1, 2, or 3 are being addressed during line time 60a.

During the second line time 60b, the voltage on common line 1 moves to a high hold voltage 72, and all modulators along common line 1 remain in a relaxed state regardless of the segment voltage applied. The modulators along common line 2 remain in a relaxed state, and the modulators (3,1), (3,2), and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the positive stability window of the modulators, and modulators (1,1) and (1,2) are actuated. Because a high segment voltage 62 is applied along segment line 3, the pixel voltage across modulator (1,3) is less than that of modulators (1,1) and (1,2), and is within the positive stability window of the modulator. Modulator (1,3) thus remains relaxed. Also during line time 60c, the voltage along common line 2 decreases to a low hold voltage 76, and the voltage along common line 3 remains at a release voltage, leaving the modulators along common lines 2 and 3 in a relaxed position.

During the fourth line time 60d, the voltage on common line 1 is at a high hold voltage 72, leaving the modulators along common line 1 in their respective addressed states. Common line 2 is now addressed by decreasing the voltage on common line 2 to a low address voltage 78. Because a high segment voltage 62 is applied along segment line 2, the pixel voltage across modulator (2,2) is below the negative stability window of the modulator, causing the modulator (2,2) to actuate. Because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage, leaving the modulators along common lines 1 and 2 in their respective addressed states. The voltage on common line 3 increases to a high address voltage to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth hold time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, it can be seen that a given write procedure includes the use of either high hold and address voltages, or low hold and address voltages. Once a high or low hold voltage is applied, the pixel voltage remains within or beyond a given stability window, and does not pass through the relaxation window until a release voltage is applied. Furthermore, as each modulator is released as part of the write procedure prior to addressing the modulator, the actuation time of a modulator, rather than the release time, determines the necessary line time. In embodiments in which the release time of a modulator is greater than the actuation time, the release voltage may be applied for longer than a single line time, as depicted in FIG. 5B. In further embodiments, voltages applied along common lines or segment lines may vary to account for variations in the actuation and release voltages of different modulators, such as modulators of different colors.

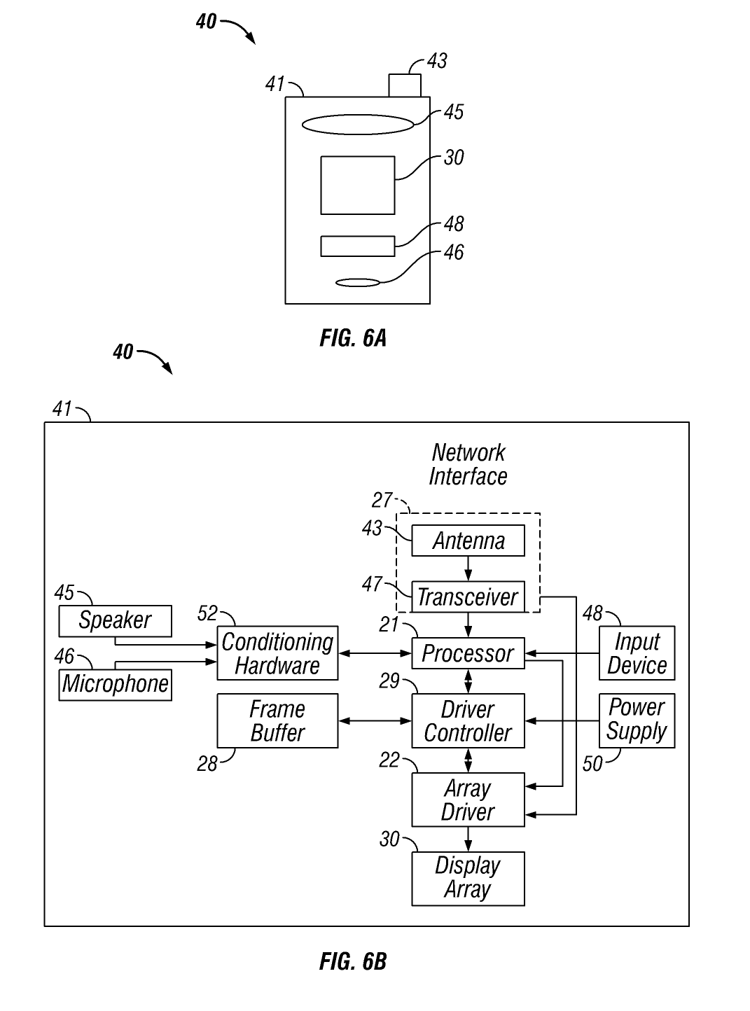

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

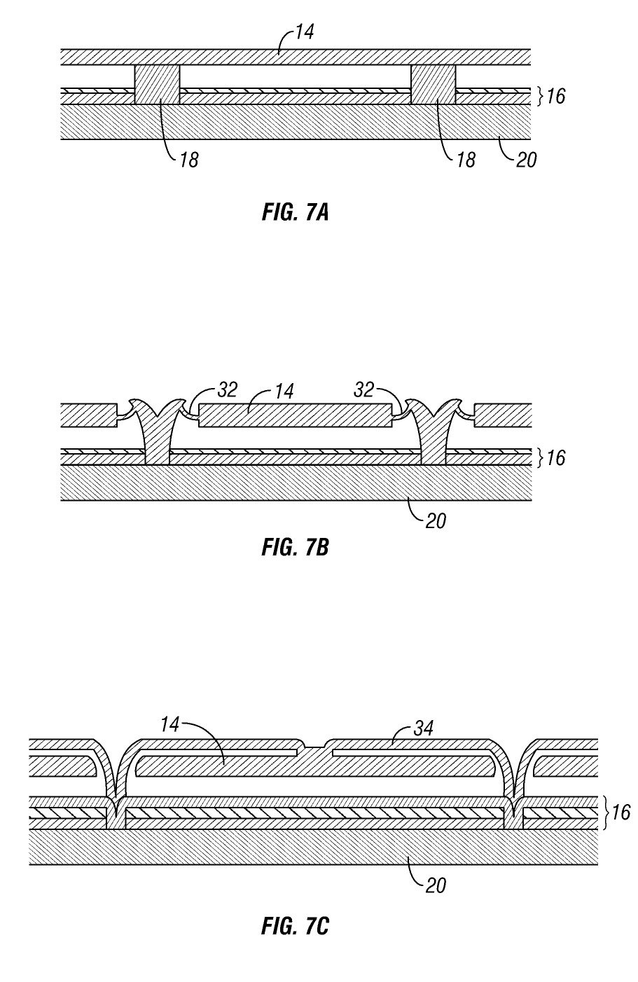

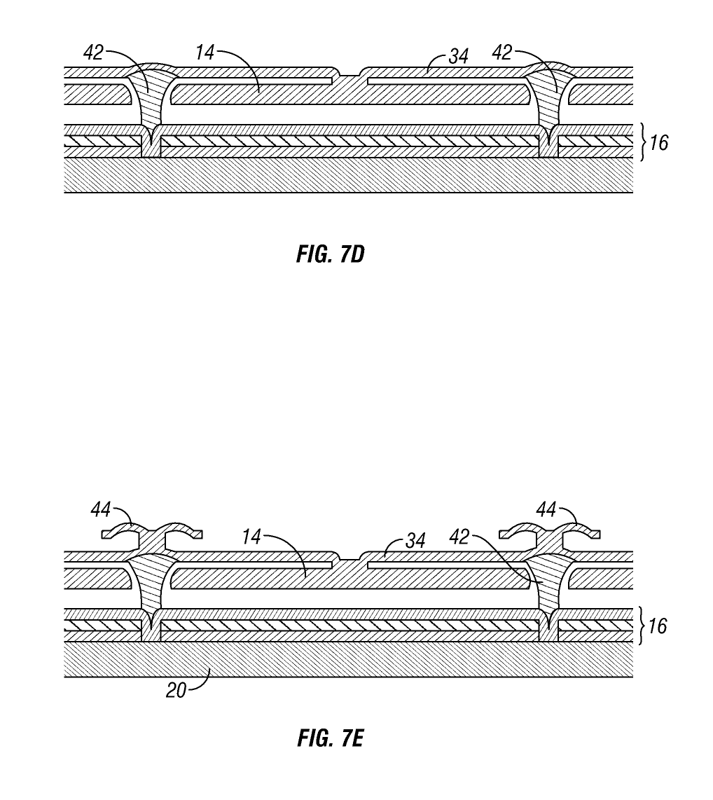

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Some embodiments of the invention involve utilizing a row-addressing order based on attributes of image data in order to update a display array using a reduced number of column voltage transitions. In order to reduce the number of column charge transitions, the system can create a row-addressing order based on the content of the image data to be written to the array. By ordering the row addressing with image content in mind, similar rows can be strobed one after the other, thereby reducing the total number of column transitions needed to write an image to the display.

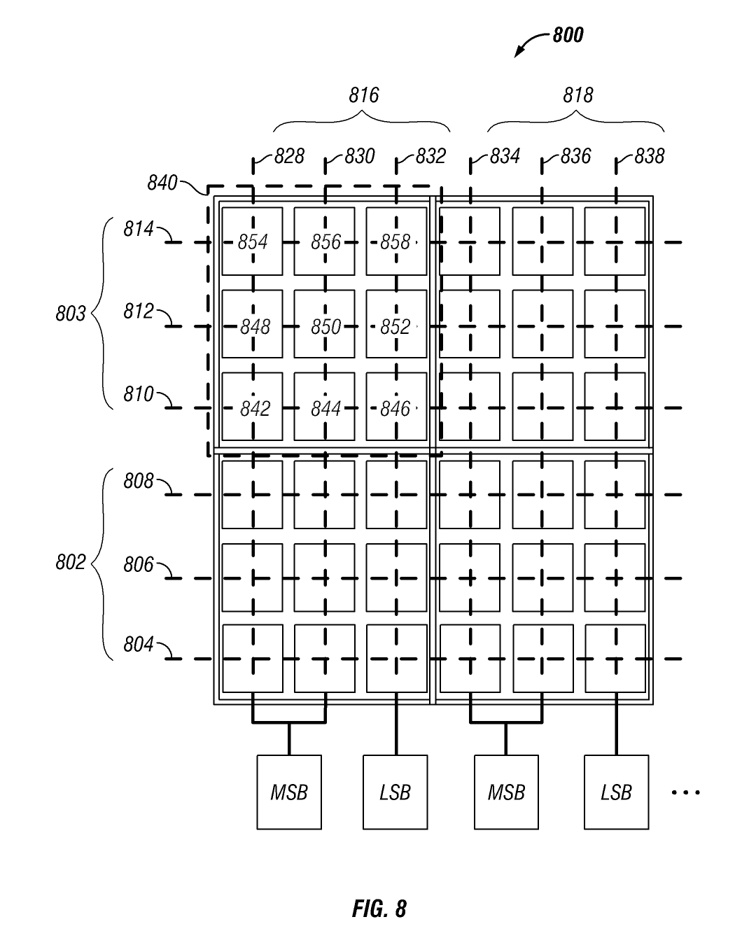

FIG. 8 illustrates an exemplary embodiment of an array 800 of display elements 801. This array 800 is an embodiment of the display array 30 described above. The array 800 includes rows 804-814 and columns 828-838. The rows 804-814 are further grouped according to color rows into lines 802, 803. For example, line 802 includes a row of red display elements 804, a row of green display elements 806, and a row of blue display elements 808. Similarly, line 803 includes a red row 810, a green row 812, and a blue row 814. The columns 828-838 are further grouped into sets 816, 818. The array 800 is also grouped into pixels. In this exemplary embodiment, the pixels include 9 display elements 801, comprising the intersection of the 3 color rows of a line and 3 columns of a set. For example, the intersection of line 803 and set 816 form a pixel 840. In an exemplary embodiment, pixel 840 includes 3 red display elements 842, 844, 846, 3 green display elements 848, 850, 852, and 3 blue display elements 854, 856, 858.

Each of the display elements 801 has a reflective state, wherein the display element 801 reflects certain wavelengths of light, and a non-reflective state, wherein the display element 801 reflects almost no light. As used herein, a display element 801 may also be referred to as being “dark” or in an actuated state (i.e. non-reflective state), or as being in a “color” or non-actuated state (i.e. reflective state).

In one embodiment, the state of each display element 801 can be represented by a bit. The value of the bit corresponds to whether the display element 801 is in a dark state (e.g., 0) or a color state (e.g., 1). In an exemplary embodiment the state of each display element 801 in each color row of a pixel is represented by the most significant bits (MSB) and a least significant bit (LSB). Accordingly, the state of all of the display elements 801 of a given pixel can be represented by the MSB and LSB for each color. In one embodiment, the state of the 2 left-most display elements 801 of a given color row of a given pixel are represented by the MSB and the state of the right most display element 801 of a given color row of a given pixel is represented by the LSB. For example, the state of red display elements 842, 844 are represented by the MSB of the red color row of pixel 840 and the state of red display element 846 is represented by the LSB of the red color row of pixel 840. Similarly in this example, the state of green display elements 848, 850 are represented by the MSB of the green color row of pixel 840 and the state of green display element 846 is represented by the LSB of the green color row of pixel 840. Further in this example, the state of blue display elements 854, 856 are represented by the MSB of the blue color row of pixel 840 and the state of blue display element 858 is represented by the LSB of the blue color row of pixel 840. In this exemplary embodiment, pixel 840 has three MSB, one for each color row, and three LSB, one for each color row. For example, a MSB of 10 and LSB of 1 for the red color row of pixel 840, corresponds to display elements 842 and 846 being in a color state and display element 844 being in a dark state.

It should be noted that the above described array is merely an exemplary array and one skilled in the art will recognize that the array may include more or fewer lines and more or fewer columns. Further, the lines may include more or fewer color rows, and the sets of columns may include more or fewer bits. Additionally, the colors of the rows may include fewer, more, or alternate colors, e.g., cyan, magenta, yellow, and/or white.

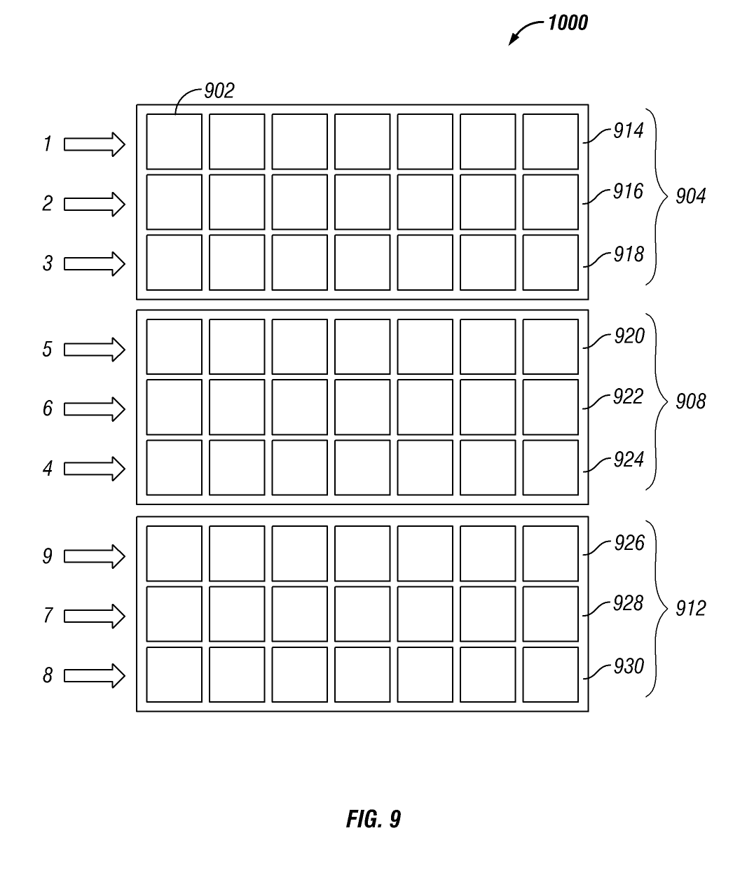

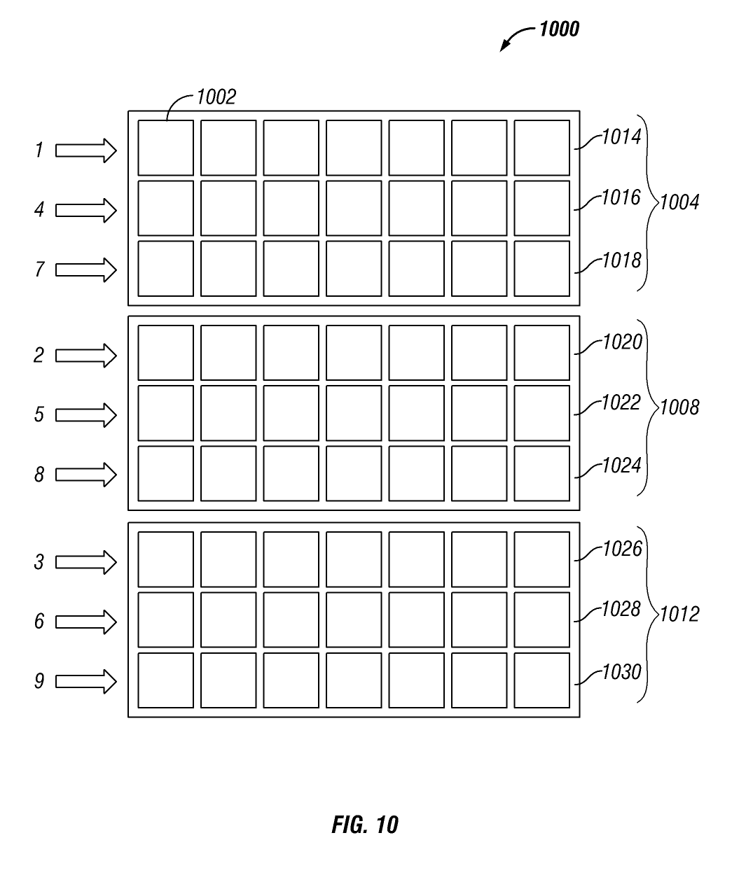

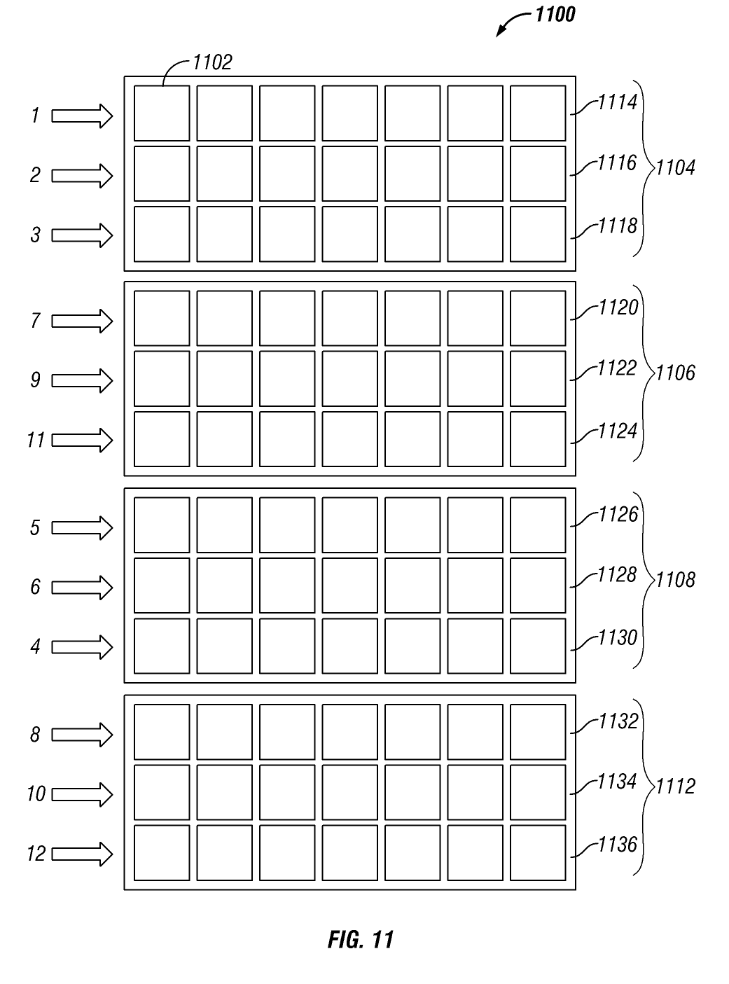

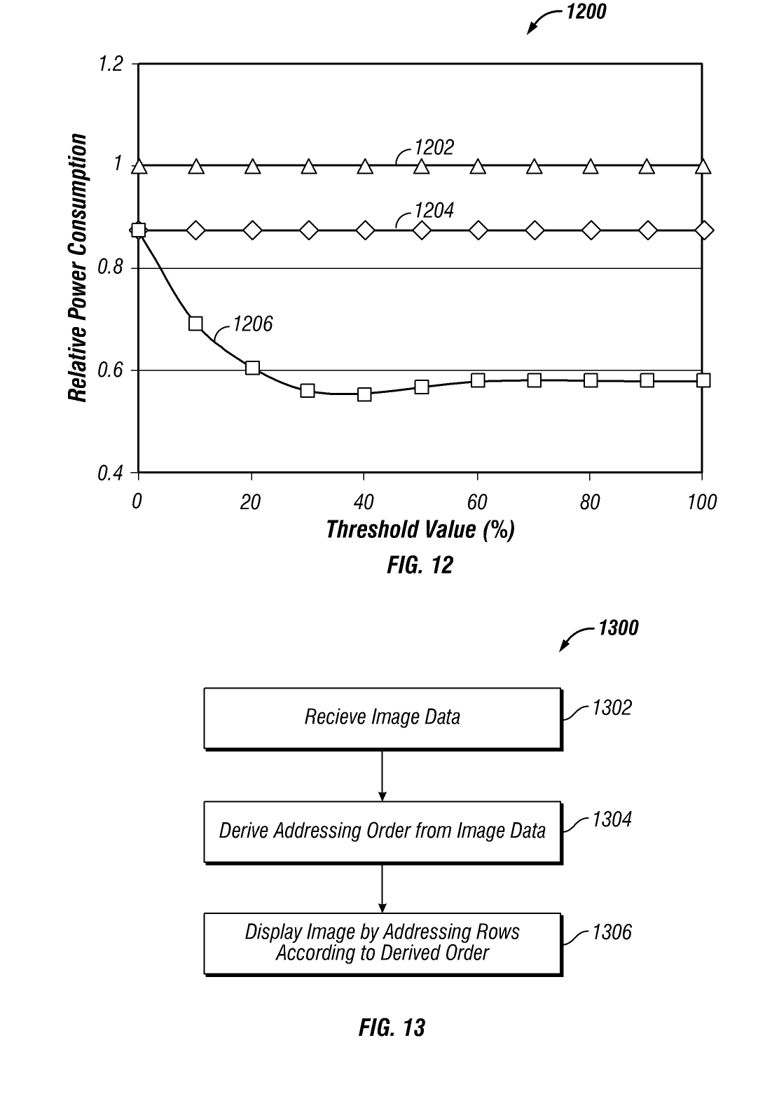

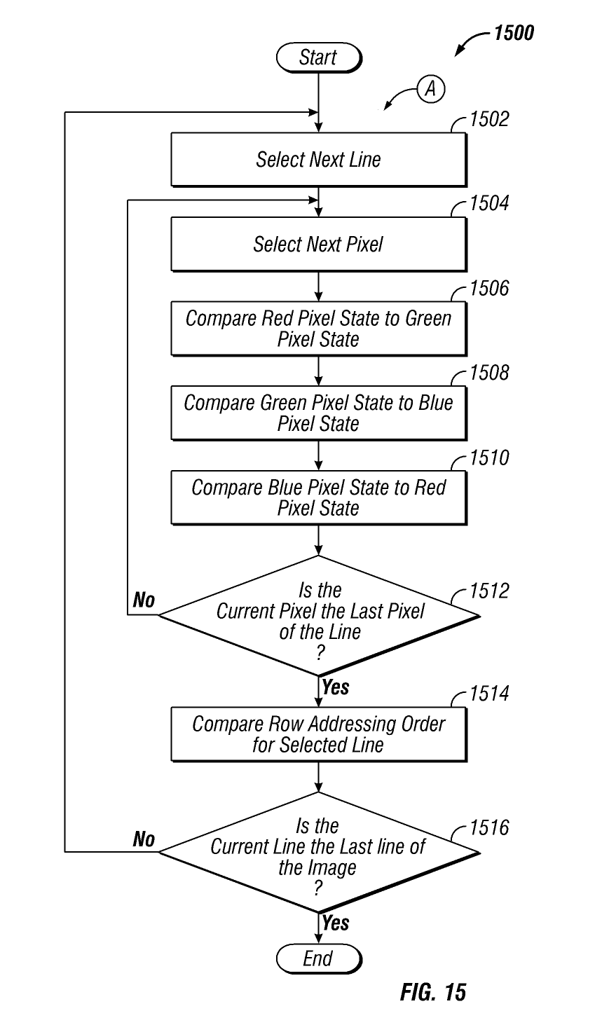

FIG. 9 is an exemplary embodiment of an array 900 where display elements 902 are addressed by a per line row sequencing scheme. In an exemplary embodiment of the per line row sequencing scheme, rows 914-930 are addressed on a per line basis, meaning each row in a line is addressed before addressing a next line of rows. In this sequencing scheme, a line is selected to be addressed and each row in that line is addressed. Subsequently, another line is selected and each row of that line is addressed. The selection of a line for sequencing may be based on any known method including random selection or selection of lines in order from top-to-bottom or bottom-to-top. For example, line 904 includes a blue row 914, a green row 916, and a red row 918. In this exemplary embodiment each row 914-918 is addressed before addressing the rows of line 908 or 912. The sequencing continues to a next line and addresses each row in that line until all of the lines 904-912 of the array 900 are addressed. In one embodiment, the lines of the array 904 are addressed in top-to-bottom order. In an exemplary embodiment, the order in which the rows of a given line are addressed is determined based on the data to be displayed such as by a process 1500 described with respect to FIG. 15. In one embodiment, the order in which the rows are addressed is chosen from one of the following color row addressing sequences: 1) blue row, green row, red row; 2) red row, blue row, green row; or 3) green row, red row, blue row. For example, with respect to FIG. 9, it is shown that for each line, the color rows of the line can have different addressing orders. Line 904 is addressed first in order of blue row 914, green row 916, and red row 918. Second, line 908 is addressed in order of red row 924, blue row 920, and green row 922. Third, line 912 is addressed in order of green row 928, red row 930, and blue row 926. It should be noted that each line may be addressed in a different order and further each color row of a line may be addressed in a different order than described above. FIG. 12, further described below, shows the relative power consumption of this approach compared to other drive schemes such as are described with respect to FIGS. 10 and 11.

FIG. 10 is an exemplary embodiment of an array 1000 where display elements 1002 are addressed by an entire array color row sequencing scheme. In an exemplary embodiment of the entire array color row sequencing scheme, rows 1014-1030 are addressed according to the color of the row, meaning each row of a first color in the array 1000 is addressed before addressing a rows of a second color in the array 1000. For example, array 900 includes blue rows 1014, 1020, 1026; green rows 1016, 1022, 1028; and red rows 1018, 1024, 1030. In one embodiment of the entire array color row sequencing scheme, the blue rows 1014, 1020, 1026 are strobed, then the green rows 1016, 1022, 1028 are strobed, and finally the red rows 1018, 1024, 1030 are strobed. It should be noted that the rows may be addressed in a different color sequence. It should also be noted that though in this exemplary embodiment color rows are addressed from top-to-bottom, other color row addressing schemes may be used e.g., bottom-to-top. FIG. 12, further described below, shows the relative power consumption of this approach compared to other drive schemes such as are described with respect to FIGS. 9 and 11.

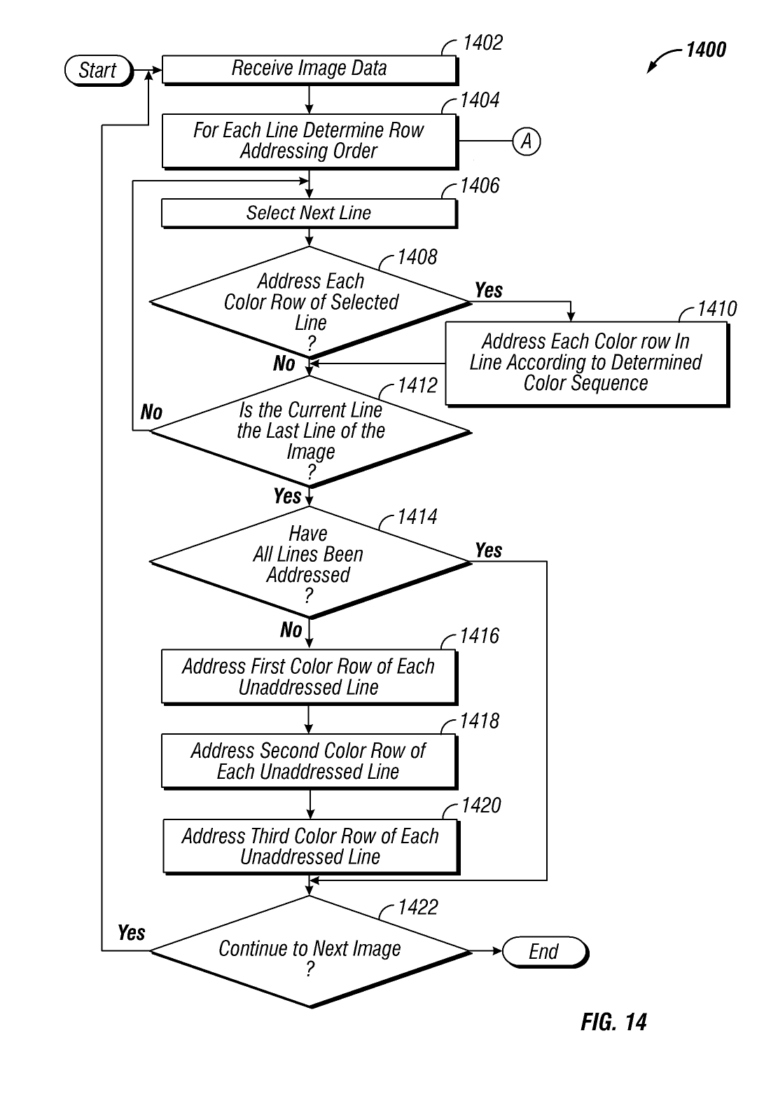

FIG. 11 is an exemplary embodiment of an array 1100 where display elements 1102 are addressed in a combination of per line row sequence and entire array color row sequence. In an exemplary embodiment, lines 1104, 1108 are addressed in per line row sequence, and lines 1106, 1112, are addressed in entire array color row sequence. In one embodiment, the lines addressed by per line row sequence are addressed first. Subsequently, the remaining lines are addressed in entire array color row sequence. For example, lines 1104, 1106 are addressed first. Line 1104 is addressed in blue 1114, green 1116, red row 1118 sequence. Line 1108 is addressed in red 1130, blue 1126, green row 1128 sequence. Lines 1108, 1112 are addressed in entire array color row sequence wherein the blow rows 1120, 1126 are addressed; then green rows 1122, 1134 are addressed; and next red rows 1124, 1136 are addressed. An exemplary embodiment of a process for selecting a sequencing scheme for addressing each row is described below with regards to FIG. 14. It should be noted that the combination sequence may also proceed with the entire array color row sequence occurring before the per line row sequence addressing scheme. Further, the lines and rows, of which there may be more or fewer, may be addressed in different orders as would be understood by one of ordinary skill in the art. FIG. 12, further described below, shows the relative power consumption of this approach compared to other drive schemes such as are described with respect to FIGS. 9 and 10.

FIG. 12 illustrates a plot 1200 of the relative power consumption of driving an array of interferometric modulators according to each of the driving sequences described in FIGS. 9, 10, and 11. In this exemplary embodiment, the y-axis is the relative power consumption of the driving scheme. The x-axis is a threshold value used to determine which scheme to use in a driving scheme that combines per line row and entire array color row sequencing. The scale of the x-axis is the percent of the maximum number of column voltage transitions that would be necessary to address a line of an array. For example, in an array with 400 display elements per row and 3 rows per line, the maximum number of column voltage transitions is 800. This is the case where all of the display elements of the second row to be addressed are in a different state than the display elements of the first row to be addressed and all of the display elements of the third row to be addressed are in a different state than the display elements of the second row to be addressed. In an exemplary embodiment, the threshold value may be 32%, which in the above example would be 256 column voltage transitions. The use of the threshold value to choose between sequencing schemes in a driving scheme such as shown in FIG. 11 is further described below with respect to FIG. 15. In an exemplary embodiment, the threshold value is programmable. In another embodiment, the threshold value is fixed. Line 1202 is a plot of the relative average power consumption for addressing an array using only a per line row sequencing scheme such as shown in FIG. 9. Line 1204 is a plot of the relative average power consumption for addressing an array using only an entire array color row sequencing scheme such as shown in FIG. 10. Line 1206 is the relative power average power consumption for addressing an array using a combination of the sequencing schemes such as shown in FIG. 11. In one embodiment, the threshold value is chosen to minimize the relative average power consumption when using a combination of the sequencing schemes. In an exemplary embodiment, the threshold value is equal to 40%. In another embodiment, the threshold value is equal to 32%. In one embodiment, the threshold value is equal to 48%.

One factor determining the power consumption from driving an interferometric modulator display is the charging and discharging of the line capacitance for the columns receiving the image data. This is due to the fact that the column voltages are switched at a very high frequency (up to the number of columns multiplied by one less than the number of rows in the array for each frame update period), compared to the relatively low frequency of the row pulses (one pulse per row per frame update period). In fact, the power consumed by the row pulses generated by row driver circuits may be ignored when estimating the power consumed in driving a display without sacrificing an accurate estimate of total power consumed. Accordingly, the term “column” as used herein is defined as the set of display inputs that receive image data at a relatively high signal transition frequency. The term “rows” is defined as the set of display inputs that receive a periodic applied signal that is independent of the display data and is applied at a relatively low frequency to each row, such as the row strobes described above. The terms “row” and “column” do not therefore imply any geometric position or relationship.

One equation for estimating the energy consumed by writing to an entire column, ignoring row pulse energy, is:

(Energy/col)=½*count*Cₗᵢₙₑ*|V_{CH}²−V_{CL}²| (1)

The power consumed in driving an entire array is the energy required for writing to every column divided by time or:

$$Power = {{\sum }_{1}}^{N} [ Energy / col ] * f \qquad ( 2 )$$

where:
N=number of columns;
count=number of transitions from V_{CH} to V_{CL}, (and vice versa) required on a given column to display data for all rows;
V_{CH}=the greater of two voltages applied to a column;
V_{CL}=the lesser of the voltages applied to a column;
Cₗᵢₙₑ=capacitance of a column line; and
f=the frame update frequency (Hz).

It should be noted that these equations are applicable to driving voltages such as those shown in FIG. 4B. Similar equations apply when negative voltages are used.

For a given frame update frequency (f) and frame size (number of columns), the power required to write to the display is linearly dependent on the frequency of the data being written. Of particular interest is the “count” variable in (1), which depends on the frequency of changes in display element states (actuated or relaxed) in a given column. Thus, by reducing the number of column voltage transitions involved in writing to the display, the amount of power consumed by the display is reduced.

FIG. 13 is a flowchart of an embodiment of a process of displaying an image on an array of interferometric modulators of the embodiment of FIG. 8. At state 1302, a display device including an array of interferometric modulators 800 may receive image data. In one embodiment, the image data is received via network interface 27, or it may be received via some other external data source such as a memory, a digital camera, a DVD player, or any other image data source that is external to the display device. In one embodiment the image data is made up of frames of images. As described below, at a next state 1304, the row addressing may be derived from the image data. In one embodiment, the row addressing is derived by processor 21. In another embodiment, the row addressing is derived by driver controller 29. In a further step 1306, the display device, via array driver 22, writes the display image on a frame-by-frame basis on the display array 30 by addressing the rows in the order set forth in step 1304. Thus, a display device may be configured to display image data according to an image dependent row-addressing order.

In another embodiment the addressing order may be included in the image file. In this embodiment, the image data may be processed before hand and the addressing order associated with the image data in a single file.

FIG. 14 is a flowchart of an embodiment of a process 1400 for addressing an array of interferometric modulators 30 such as the array 800 of the embodiment of FIG. 8. The steps of process 1400 may be performed by processor 21, driver controller 29, array driver 22, and/or as otherwise indicated. At step 1402, image data is received (e.g., a frame). In one embodiment, the image data is received via network interface 27, or it may be received via some other external data source such as a memory, a digital camera, a DVD player, or any other image data source that is external to the display device. Next, at a step 1404, a row addressing order is determined for each line, selected from per line row sequence and entire array color row sequence described above with respect to FIGS. 9 and 10. The row addressing order for each line is determined based on attributes of the image data in order to reduce the number of column voltage transitions necessary for addressing the array. Similar rows are addressed one after the other, thereby reducing the total number of column transitions needed to address the array. An exemplary embodiment of determining an addressing order for color rows in a line is described in more detail below with respect to FIG. 15. Process 1400 continues to a step 1406, where a line that has not been selected for the present image is selected. In an exemplary embodiment, the line is the top-most line of the array that has not yet been selected. Further, in a step 1408, it is checked whether the determining step 1404 set the line selected in step 1406 to be addressed in per line row sequence. If the answer to decision step 1408 is yes, in a further step 1410, each row of the selected line is addressed by array driver 22 in the color sequence determined at step 1404. The process 1400 continues to step 1412. If the decision made at step 1408 is that the selected line is not set to be addressed in per line row sequence, the process 1400 continues to step 1412. In step 1412 it is determined if the selected line is the last line to be addressed of the array. In the exemplary embodiment, the last line is the bottom-most line of the array. If it is determined the selected line is not the last line, the process returns to step 1406. If, however, at step 1412 it is determined that the selected line is the last line of the image, the process 1400 proceeds to a step 1414.

At step 1414 of the process 1400, it is determined whether all the lines of the array have been addressed. If it is determined all lines have been addressed the process 1400 continues to a step 1422 described below. If it is determined all the lines have not been addressed, the process 1400 proceeds to a further step 1416. In step 1416, a first color row is addressed by array driver 22 for each line that has not yet been addressed. For example, if an array includes lines 1-5 and lines 2 and 4 have not been addressed, a first color row of line 2 and line 4 is addressed. The first color row is selected from the set of color rows in each line. In an exemplary embodiment, the first color row is the top-most color row of each line. In another embodiment, each line includes a red row, a blue row, and a green row. In one embodiment, the first color row is the blue row. The process 1400 then proceeds to a step 1418 where a second color row of the set of color rows not yet addressed in each line is selected. The second color row is addressed by array driver 22. In the exemplary embodiment, the second color row is the second color row from the top color row of each line. In one embodiment, the second color row is the green row. The process 1400 then proceeds to a step 1420 where a third color row of the set of color rows not yet addressed in each line is selected. The third color row is addressed by array driver 22. In the exemplary embodiment, the third color row is the third color row from the top color row of each line. In one embodiment, the third color row is the red row. In a further step 1422, it is determined whether to continue to a next image. If the decision is made to continue, the process 1400 returns to step 1402. If the decision is made not to continue, the process 1400 ends.

FIG. 15 is a flowchart of an embodiment of a process 1500 for determining the row addressing order for each line of image data. Process 1500 is an exemplary embodiment of step 1404 of process 1400. In an exemplary embodiment, the steps of process 1500 are performed by processor 21 or by driver controller 29. At a step 1502 a line that has not been selected for the present image is selected. In an exemplary embodiment, the line is the top-most line of the array that has not yet been selected. In one embodiment of step 1502, counters or accumulate registers A, B, and C are initialized to 0. The process 1500 then proceeds to step 1504. At step 1504, a pixel that has not been selected for the selected line is selected. In an exemplary embodiment, the pixel is the left-most pixel in the selected line that has not yet been selected. In a further step 1506, the state (e.g., dark or color) of the red display elements of the selected pixel, is compared to the state of the green display elements of the selected pixel. An approximation of the similarity between the state of the red display elements and the green display elements is then made.

In one embodiment the MSB of the red color row of the selected pixel is compared to the MSB of the green color row. Further the LSB of the red color row is compared to the LSB of the green color row. In one embodiment, the comparison comprises an exclusive-or (xor) performed by xor gates. In this embodiment the xor between the MSBs results in a 0 or 1 value and the xor between the LSBs results in a second 0 or 1 value. In an exemplary embodiment, the result of the xor between the MSBs is multiplied by 2 and summed with the xor between the LSBs. This sum is added to the value of A. Process 1500 then continues to a step 1508.

In step 1508, the state of the green display elements of the pixel is compared to the state of the blue display elements of the pixel. An approximation of the similarity between the state of the green display elements and the blue display elements is then made. In one embodiment the MSB of the green color row is compared to the MSB of the blue color row. Further the LSB of the green color row is compared to the LSB of the blue color row. In one embodiment, the comparison comprises an exclusive-or (xor) performed by xor gates. In this embodiment the xor between the MSBs results in a 0 or 1 value and the xor between the LSBs results in a second 0 or 1 value. In an exemplary embodiment, the result of the xor between the MSBs is multiplied by 2 and summed with the xor between the LSBs. This sum is added to the value of B. Process 1500 then proceeds to a step 1510.

In step 1510, the state of the blue display elements of the pixel is compared to the state of the red display elements of the pixel. An approximation of the similarity between the state of the blue display elements and the red display elements is then made. In one embodiment the MSB of the blue color row is compared to the MSB of the red color row. Further the LSB of the blue color row is compared to the LSB of the red color row. In one embodiment, the comparison comprises an exclusive-or (xor) performed by xor gates. In this embodiment the xor between the MSBs results in a 0 or 1 value and the xor between the LSBs results in a second 0 or 1 value. In an exemplary embodiment, the result of the xor between the MSBs is multiplied by 2 and summed with the xor between the LSBs. This sum is added to the value of C. Next, in a decision step 1512, it is determined by processor 21 if the current pixel is the last pixel of the line (i.e., all the pixels of the selected line have been selected). In an exemplary embodiment, the last pixel of the line is the right most pixel of the line. If it is determined the pixel is not the last pixel, the process 1500 returns to step 1504. If it is determined the pixel is the last pixel of the line, the process 1500 continues to a step 1514.

In step 1514, the row addressing order is determined for the selected line. The row order is based on the comparisons made in steps 1506-1510. If the color rows for the selected line are not similar, then the line is set to be addressed by entire array color row sequence. In an exemplary embodiment, similarity is determined by summing the determined A and B values and comparing the sum to a threshold value using a comparison register. This sum is an approximation of the number of column voltage transitions necessary for addressing the selected line in per line row sequence. If the sum is greater than the threshold value, the line is set to be addressed by entire array color row sequence. If the sum is less than the threshold value, the line is set to be addressed by per line row sequence. In an exemplary embodiment, the threshold value is programmable. In another embodiment, the threshold value is fixed. In one embodiment, the threshold value is around 0.4*numSegs, where numSegs is the maximum number of column voltage transitions necessary for a given line. As described above with respect to FIG. 12, the maximum number of column voltage transitions is equal to the number of display elements per row of a line (NumElem) multiplied by 1 less than the number of rows (NumRows) (i.e., NumElem*(NumRows−1)). For an array with 3 rows per line and 400 display elements per row, numSegs would equal 800 (i.e., 400*(3−1)). In this example, the threshold value would be 320.

If the sum of A and B is less than the threshold value, the per line row sequence for the line is selected to minimize the number of column voltage transitions required to address color rows of a line. In one exemplary embodiment, the addressing sequence is chosen according to a comparison of the values of A, B, and C using comparison registers. If A is the maximum value, the line is set to be addressed in green, blue, red order. If B is the maximum value, the line is set to be addressed in blue, red, green order. If C is the maximum value, the line is set to be addressed in red, green, blue order. In one embodiment, the row addressing order for a line is indicated by a flag value for the line. It should be noted that one of ordinary skill in the art will recognize that other color addressing sequences may be used without increasing complexity of computation.

Process 1500 then continues to a decision step 1516, where it is determined whether the currently selected line is the last line of the image (i.e., all lines have been selected). If the line is not the last line of the image, the process 1500 returns to step 1502. If the line is the last line of the image, the process 1500 ends.

In an exemplary embodiment, the hardware necessary to implement process 1500 comprises 6 xor gates, 3 accumulate registers, 3 comparison registers, 2 flag bits per line, and some state machine logic.

While the above processes 1300, 1400, and 1500 are described in the detailed description as including certain steps and are described in a particular order, it should be recognized that these processes may include additional steps or may omit some of the steps described. Further, each of the steps of the processes does not necessarily need to be performed in the order it is described.

While the above detailed description has shown, described and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of writing a display image to a display having an array of pixels, comprising:
for at least one line in a frame, selecting from at least one of two predefined driving sequences;
writing data to a display in accordance with the selected driving sequence,
wherein one of the driving sequences comprises addressing each color row in the selected line in a sequence before addressing a second line, and
wherein one of the driving sequences comprises addressing a first color row of each line in the frame before addressing a second color row of each line in the frame.

2. The method of claim 1, wherein the driving sequence is selected from one of: a red row of the selected line, a green row of the selected line, a blue row of the selected line; the green row, the blue row, the red row; and the blue row the red row, the green row.

3. The method of claim 1, wherein selecting from at least one of two predefined driving sequences comprises:
for each line in the frame, comparing a blue row to a red row, comparing the blue row to a green row, and comparing the red row to the green row; and
selecting from at least one of two predefined driving sequences based on the comparisons.

4. The method of claim 1, wherein the display is a bi-stable display comprising an array of pixels, said pixels having an actuated state and an un-actuated state.

5. The method of claim 5, wherein the pixels in the array comprise interferometric modulator pixels.

6. The method of claim 1, wherein each line comprises three color rows.

7. The method of claim 6, wherein comparing at least two color rows comprises:
comparing a first color row to a second color row;
comparing the first color row to a third color row; and
comparing the second color row to the third color row.

8. A method of writing a display image to a display having an array of pixels comprising:
for at least one line in a frame, comparing at least two color rows; and
selecting from at least one of two predefined driving sequences based on the comparison.

9. The method of claim 8, further comprising writing to a display in accordance with the selected driving sequence.

10. The method of claim 8, wherein the display is a bi-stable display comprising an array of pixels, said pixels having an actuated state and an un-actuated state.

11. The method of claim 10, wherein the pixels in the array comprise interferometric modulator pixels.

12. The method of claim 8, wherein each line comprises three color rows.

13. The method of claim 12, wherein comparing at least two color rows comprises:
comparing a first color row to a second color row;
comparing the first color row to a third color row; and
comparing the second color row to the third color row.

14. A display apparatus comprising:
a memory storing image data;
a processor configured to receive said image data and select from at least one of two pre-defined row-addressing order based on comparison of at least two color rows for one or more lines of the image data; and
a controller configured to present the image data to a display on a row-by-row basis according to the selected pre-defined row-addressing order.

15. The display apparatus of claim 14, wherein the at least one of two pre-defined row addressing order is selected from one of:
addressing each color row in the selected line in a sequence before addressing a second line; and
addressing a first color row of each line in the frame before addressing a second color row of each line in the frame.

16. The display apparatus of claim 14, wherein the pre-defined row-addressing order for each line is selected from one of: a red row of the selected line, a green row of the selected line, a blue row of the selected line; the green row, the blue row, the red row; and the blue row the red row, the green row.

17. The display apparatus of claim 14, wherein the comparison of at least two color rows for one or more lines of the image data comprises:
for each line, comparing a first color row to a second color row;
for each line, comparing the first color row to a third color row; and
for each line, comparing the second color row to the third color row.

18. The display apparatus of claim 14, wherein the memory is a frame buffer.

19. The display apparatus of claim 14, further comprising:
a processor that is configured to communicate with said display, said processor being configured to process image data; and
a memory device that is configured to communicate with said processor.

20. The display apparatus as recited in claim 19, further comprising a driver circuit configured to send at least one signal to said display.

21. The display apparatus as recited in claim 19, further comprising a controller configured to send at least a portion of said image data to said driver circuit.

22. The display apparatus as recited in claim 19, further comprising an image source module configured to send image data to said processor.

23. The display apparatus as recited in claim 22, wherein said image source module comprises at least one of a receiver, transceiver, and transmitter.

24. The display apparatus of recited in claim 19, further comprising an input device configured to receive input data and to communicate said input data to said processor.

25. A display apparatus comprising:
means for receiving image data;
means for comparing at least two color rows for one or more lines of the image data;
means for selecting from at least one of two pre-defined row-addressing orders based on said comparison; and
means for presenting the image data to a display in accordance with the selected row-addressing order.

26. The display apparatus of claim 25, wherein the receiving means comprises a processor.

27. The display apparatus of claim 25, wherein the receiving means comprises a driver controller.

28. The display apparatus of claim 25, wherein the receiving means comprises an array driver.

29. The display apparatus of claim 25, wherein the comparing means comprises a processor.

30. The display apparatus of claim 25, wherein the comparing means comprises a driver controller.

31. The display apparatus of claim 25, wherein the comparing means comprises an array driver.

32. The display apparatus of claim 25, wherein the selecting means comprises a processor.

33. The display apparatus of claim 25, wherein the selecting means comprises a driver controller.

34. The display apparatus of claim 25, wherein the selecting means comprises an array driver.

35. The display apparatus of claim 25, wherein the presenting means comprises an array driver.

36. The display apparatus of claim 25, wherein the at least one of two pre-defined row addressing order is selected from one of:
addressing each color row in the selected line in a sequence before addressing a second line; and
addressing a first color row of each line in the frame before addressing a second color row of each line in the frame.

37. The display apparatus of claim 25, wherein the pre-defined row-addressing order for each line is selected from one of: a red row of the selected line, a green row of the selected line, a blue row of the selected line; the green row, the blue row, the red row; and the blue row the red row, the green row.

38. The display apparatus of claim 25, wherein the comparison of at least two color rows for one or more lines of the image data comprises:
for each line, comparing a first color row to a second color row;
for each line, comparing the first color row to a third color row; and
for each line, comparing the second color row to the third color row.
